(19) United States
(12) Patent Application Publication
(10) Pub. No.: US 2022/0161293 A1
(43) Pub. Date: May 26, 2022

(54) LASER ABLATED PAINT OVER SURFACE TREATED CHROME

(71) Applicant: LACKS ENTERPRISES, INC., Grand Rapids, MI (US)

(72) Inventors: Matthew Graham, Portland, MI (US); Thomas Hawkins, Grand Rapids, MI (US); Tam TRAN, Grand Rapids, MI (US); Garry Van Houten, Middleville, MI (US)

(21) Appl. No.: 17/533,721

(22) Filed: Nov. 23, 2021

Related U.S. Application Data
(60) Provisional application No. 63/116,998, filed on Nov. 23, 2020.

(51) Int. Cl. B05D 3/06; B44C 1/22

(52) U.S. Cl. CPC B05D 3/06; B05D 5/067; B44C 1/228

(57) ABSTRACT

A system and method of creating a decorative component having multiple surface finishes includes providing a substrate with a metal surface layer and treating the metal surface layer to remove oxidation, and applying a coating or paint layer over at least a portion of the treated metal surface layer. The paint layer is removed via laser ablation to define a metal-paint interface. The metal-paint interface created by laser ablation applied to paint over treated metal is free from adhesion failure. The workpiece created includes multiple surfaces having complex shapes and features, and may be applied to a variety of surfaces. Multiple surface finishes are therefore created on a single part without the need for assembly of separate parts, with a robust interface between contrasting surface appearances.

### CROSS-REFERENCE TO RELATED APPLICATIONS

The present application claims the benefit of previously filed U.S. Provisional Application No. 63/116,998, filed Nov. 23, 2020, the entire content of which is hereby incorporated by reference in its entirety.

### FIELD

The present disclosure is directed to decorative components for use in, for example, automotive, appliance, and consumer electronics markets. More particularly, the present disclosure is related to decorative components having a metal surface with an applied painted feature thereon and a paint-metal interface.

### BACKGROUND

Plated decorative chrome finishes have been commercially available for various products in the automotive, appliance, consumer electronics, and other markets for many years.

As technologies and consumer tastes have matured, the desire for more complicated parts and designs has evolved. For example, it has become more desirable to incorporate paint over chrome surfaces in order to take advantage of the reflectivity of the substrate through a translucent coating, or to selectively paint a chrome surface with opaque or translucent coatings.

One approach to applying translucent or opaque coatings includes the use of selective painting onto the chrome surface Selectively painted surfaces can be achieved using masks to obscure areas where paint is not desired. This masking and painting process adds cost and limits part designs, as the mask must have a shape that complements the shape of the component, and is difficult to apply to a curved surface. Additionally, the interface at the edge of the paint that is applied can be susceptible to peeling.

It is well known in the art that organic coatings do not adhere robustly to chrome metal surfaces due to the passive chromium oxide surface layer that is naturally formed over time. It has been shown that painting a freshly plated chrome metal surface can enhance paint adhesion. U.S. Pat. No. 7,597,935 Xu et al (“Xu”) demonstrates a process for removing the chromium oxide surface layer and exposing a fresh chromium surface followed by immediate painting. The process of Xu has the advantage of creating a fresh chromium surface that can be repeatedly reproduced which overcomes the limitations of attempting to transfer parts from a plating operation to a paint operation quickly. Environmental effects such as temperature and humidity are factors that determine how quickly this passivation layer (the passive chromium oxide layer that is removed) can build and become a barrier to good paint adhesion. While Xu's process can provide a surface where paint adhesion is possible, Xu may still require the use masking and can result in interfaces that are susceptible to peeling.

In view of the above, improvements can be made to the selective painting or coating of metallic parts.

### SUMMARY

It is an object of the disclosure to selectively coat parts of various designs and shapes or to impart a graphic design onto the surface such that no added tooling that is specific to the part is needed.

This disclosure relates to a method that produces a selectively coated chrome or chrome treated metal surface by first surface treating the chrome metal surface, followed by a paint step, and finally selective removal of portions of the paint via laser ablation.

According to an aspect of the disclosure, a decorative component for an automotive vehicle includes: a substrate having an outer metal surface; wherein the outer metal surface is substantially free from oxidation following an oxidation removal treatment process to define a treated metal surface; a paint or coating layer applied and adhered to the treated outer metal surface; a portion of the paint or coating layer removed by a laser ablation process to expose a portion of the metal layer to define a paint-metal interface.

In one aspect, a primer layer is applied on the outer metal surface and disposed between the outer metal surface and the paint or coating layer.

In one aspect, the treatment process defining the treated metal surface occurs prior to painting.

In one aspect, the paint-metal interface is free from adhesion failure.

In one aspect, the component includes multiple surface finishes to define a graphic on the component.

In one aspect, the paint-metal interface is disposed on a flat surface of the component.

In one aspect, the paint-metal interface is disposed on a curved surface of the component.

In one aspect, the metal substrate has a textured surface including a plurality of protruding features.

In one aspect, the textured surface defines a plurality of peaks and valleys.

In one aspect, the peaks define an exposed metal surface formed by laser ablation and the paint-metal interface is disposed on a side surface of the protruding features.

In one aspect, the valleys define an exposed metal surface formed by laser ablation and the paint-metal interface is disposed on a side surface of the protruding features.

In one aspect, the metal substrate consists of a chrome metal part.

In another aspect, a method of creating a surface finish on a decorative component for an automobile includes: providing a workpiece formed of a metal material, the workpiece having an outer metal surface; treating the outer metal surface with an oxidation removal treatment process and defining a treated metal layer; after treating the outer metal surface to define the treated metal layer, applying a paint layer over the treated metal layer; removing a portion of the paint layer using laser ablation and defining a metal-paint interface.

In one aspect, the step of treating the metal material comprises applying a primer layer to outer metal surface.

In one aspect, the method includes applying a mask to a portion of the treated metal layer prior to applying the paint layer, and performing laser ablation after applying the mask and the paint layer, wherein the laser ablation removes paint-metal interfaces defined by the mask.

In one aspect, the outer metal surface includes a textured surface with a plurality of surface features defining peaks and valleys.

In one aspect, the step of removing a portion of the paint layer comprises removing a portion of the paint layer from the peaks and retaining the paint layer in the valleys.

In one aspect, the step of removing a portion of the paint layer comprises removing a portion of the paint layer from the valleys and retaining the paint layer on the peaks.

In one aspect, the method includes rotating the workpiece during laser ablation.

In one aspect, the laser ablation creates a crisp metal-paint interface free from adhesion failure.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 illustrates a process for creating a decorative component with multiple surface finishes according to an aspect of the present disclosure;

FIG. 2A illustrates a workpiece with a paint applied over an untreated metal surface;

FIG. 2B illustrates the workpiece of FIG. 2A following CASS testing and illustrating adhesion failure at the paint-metal interface;

FIG. 3 illustrates a workpiece created according to an aspect of the present disclosure;

FIG. 4 illustrates another workpiece according to an aspect of the present disclosure;

FIG. 5A is a schematic cross-section view of a workpiece according to the present disclosure having a textured surface with a paint layer applied over a treated metal layer;

FIG. 5B is a schematic cross-section view of the workpiece of FIG. 5A following laser ablation to remove a portion of the paint layer to expose the chrome layer;

FIG. 5C is a schematic cross-section view of a metal layer applied over a portion of the substrate to expose a portion of the substrate; and

FIG. 6 is an exploded view illustrating the use of mask for applying the paint layer according to an aspect of the disclosure.

### DETAILED DESCRIPTION

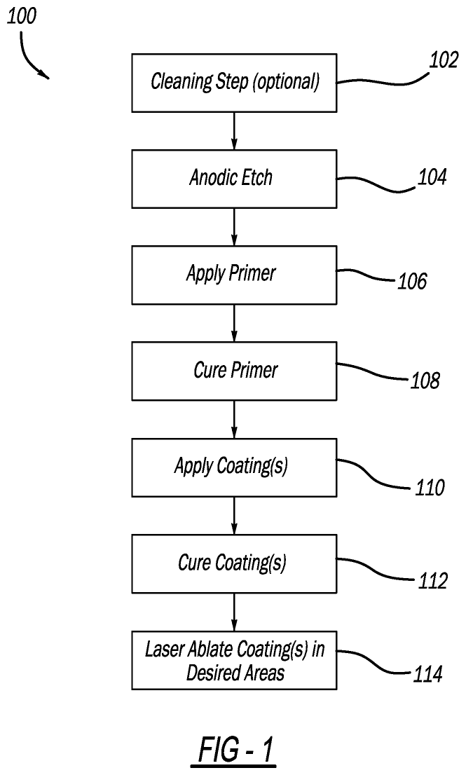

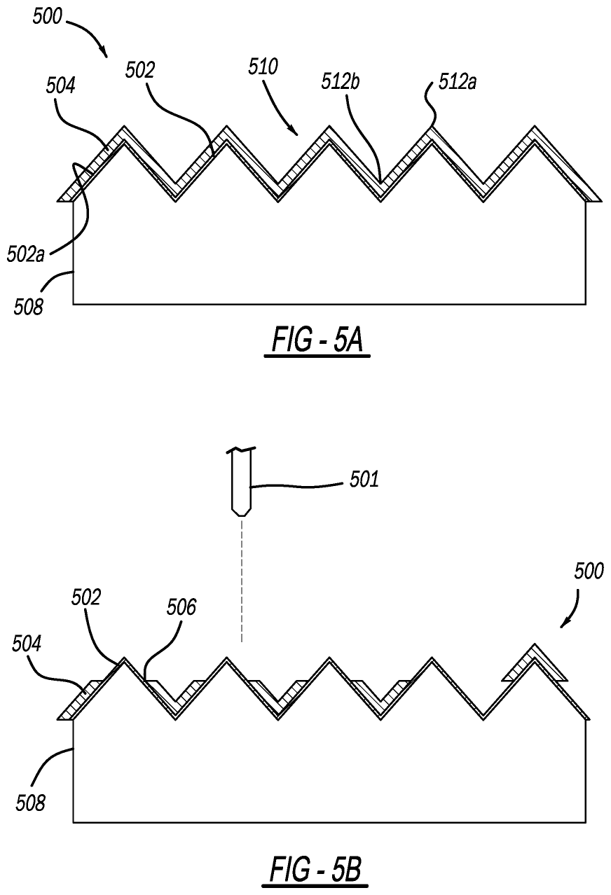

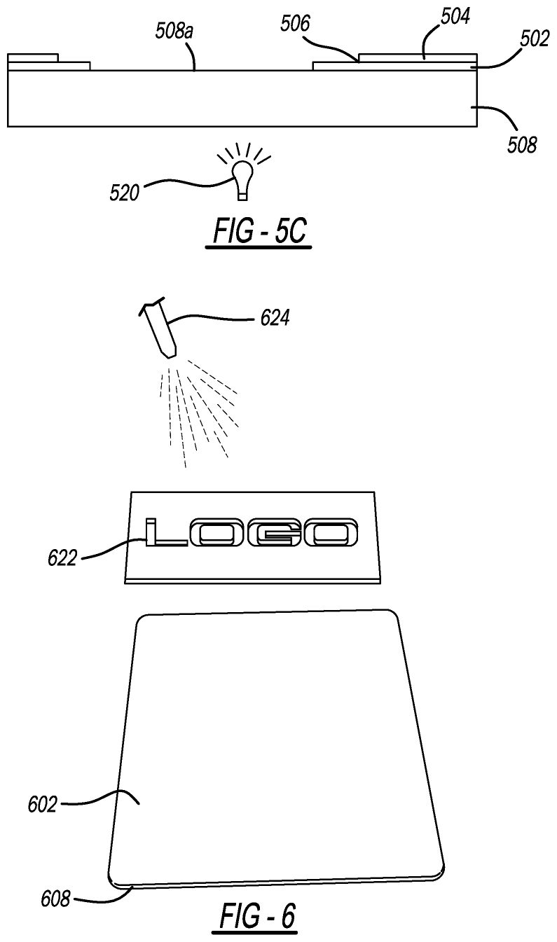

FIG. 1 illustrates a process 100 according to the present disclosure, including the provision of a component with a metal surface, such as a chrome plated part, that is treated and painted, with a portion of the paint removed after being applied. It will be appreciated that some of the steps of the process 100 are described in detail by Xu. Reference may be made to part 500 illustrated in FIGS. 5A-5B, which illustrates an aspect of the present disclosure.

The process 100 includes providing a part 508 having an outer metal surface 502. One example of such a part 508 with metal surface 502 shown in FIG. 5A. In one aspect, the outer metal surface is a chrome surface. The process preparing the chrome surface for being painted may begin with an optional cleaning step 102 to remove unwanted dirt, particulates or oils from the chrome-plated part. In another aspect, the cleaning step may not be performed, for example in cases where parts are relatively quickly transferred or provided following the creation of the chrome layer 502, such that dirt or other surface impurities have not had sufficient opportunity to accumulate on the surface.

Following the provision of the part 508 and the optional cleaning step 102, the process 100 includes anodically etching 104 the chrome surface 502 (as described in Example 2 of Xu), which involves application of anodic current to the chrome surface in a CrO3 solution to remove the passivation layer and expose a fresh chrome surface. In this step, the part may be immersed in the CrO3 solution, and following the immersion, the anodic current may be applied, resulting in removal of the passivation layer. The etching step 104 may also be described as defining a treated metal layer or a treated metal surface. The chrome surface 502 of the part may also be described as an outer metal layer 502, such that the outer metal layer 502 is treated and a treated metal layer 502 is defined by the etching step 104.

With a fresh chrome surface 502, or treated metal surface 502, being created after step 104, the process 100 may continue by applying 106 a primer (described in Example 8 of Xu) which consists of a pH stabilized dilute solution of polyacrylic acid and hydrolyzed silane coupling agent to define a primer layer 502a. Xu describes the use of a silane coupling agent as a key compound in the process and demonstrates usage of gamma-glycidoxypropyltrimethoxysilane. Primer layer 502a is shown for example in FIG. 5B.

In another aspect, other coupling agents may also be employed and may be selected dependent on the type of paint system to be used over the primer layer 502a. It is not the intent of the present disclosure to limit the use of coupling agents to only silanes or those described in Xu. Other coupling agents such as functionalized trimethoxytitanates or zirconates could also be employed among many other possibilities. Application 106 of the primer layer 502a can be accomplished in a number of ways including dipping, flow coating, curtain coating, or spraying.

The primer layer 502a may be applied to selective areas of the part, or may be applied more generally. Application of the primer layer 502a improves the adhesion of the paint or coating layer 504 that is later applied. In one aspect, the primer layer 502a may be interpreted as being disposed between the treated metal layer 502 and the paint layer 504 that is later applied. In another aspect the primer layer 502a may be interpreted as being part of the treated metal layer 502. It will be appreciated that reference to the paint or coating layer 504 being applied to the treated metal layer 502 does not exclude instances where the primer layer 502a is disposed on the treated metal layer 502 ahead of the paint or coating layer 504.

Once applied in step 106, the primer layer 502a may then be cured in step 108 and may be dried for at least 30 minutes at 180 F as part of the curing process. Of course, other temperatures may be used along with other time periods. Following the curing and drying of the primer layer 502a, the part can then be painted or coated as further described below.

In step 110, a paint or coating layer (or multiple paint or coating layers), such as paint layer 504 shown in FIGS. 5A and 5B, may then be applied by any method that produces the desired finish. The painting or coating may be accomplished via dipping, flow coating, curtain coating, or spraying. Such painting or coating methods may also include curing the paint or coating layer 504 in step 112, which follows the application step 110. The painting or coating may be applied to selected areas or portions of the part, or may be applied more generally across the part.

With continued reference to FIG. 1, once the paint or coating layers 504 have been applied and cured in steps 110-112, the paint or coating layer 504 may be considered sufficiently adhered and applied to the part. However, such painting processes may be insufficient to produce a detailed design, shape, or graphic on the part. Indeed, the painting process may result in rough or ill-defined interfaces or edges between the paint or coating layer 504 and the underlying metal surface 502.

To create a desired shape or pattern of the applied paint layer 504, the part may be subjected to laser ablation in step 114. Laser ablation includes the process of applying a laser (such as laser 501 shown schematically in FIG. 5B) to the painted layer 504 that was applied over the metal surface 502, thereby removing portions of the painted layer 504 from the part and creating a more well-defined shape and edge of the painted surface. The type of laser, wattage, beam size, and speed of the laser ablation system are optimized for clean paint removal and efficiency. Paint layers 504 such as those described herein have been successfully ablated using various lasers in the range from IR to UV.

The power utilized for the laser 501 may vary for a UV laser and/or an IR laser. The frequency of the laser 501 and pulse width of the laser 501 may also vary. The spot size of the laser 501 is another aspect of the laser can be varied to suit the needs of the specific part. Indeed, it will be appreciated that the watts, frequency, pulse width, spot size, range, etc. may vary to alter the removal properties of the laser.

In one aspect, the removal properties of the laser 501 are selected such that the laser 501, when activated to remove paint that has been applied over the chrome, will remove the paint without damaging the underlying chrome such that the chrome layer will still meet or exceed the desired performance requirements. Specific performance requirements may vary among different part types and applications, and the laser 501 can therefore be tailored according to such design aspects. In one aspect, the laser 501 may be set to remove paint from the underlying chrome such that there is no need for any post-cleaning steps, thereby providing further manufacturing efficiencies.

Removal of the paint layer 504 can create complex patterns and shapes that are difficult or virtually impossible to create via traditional paint-on-metal processes. The laser ablation process allows for various curved and/or intersecting paths of removed material of the paint layer 504. The laser ablation process may be used to create stippling or other varied dots and spots to define a shading or gradient pattern that defines a graphic or image that is visible to consumers from a distance.

The removal of the paint layer 504 may be used to create both positive and negative shapes. For example, paint layer 504 may be removed to leave behind a painted layer 504 that forms the desired shape. Alternatively, paint may be removed, where the removed area defines the desired shape. Moreover, a combination of positive and negative space may be used to define a desired design.

The laser ablated paint over chrome system and process 100 of the present disclosure is advantageous because it provides the appearance of two finishes (painted surface and metal-plated surface visible through the paint or coating) on the same part. Accordingly, separate assembled pieces having different appearances are not required, thus saving time and cost associated with the assembly of such different parts. Additionally, providing the multiple finishes on a single part provides a more robust component that is not susceptible to disassembly or failure of a joining or fastening structure that is used to connect two separate parts. Additionally, the shape of the contrasting features creating via the disclosed process 100 may not be possible via assembly of separate parts.

In one aspect, another embodiment of the present disclosure involves using a mask (such as mask 622 shown in FIG. 6) to selectively paint portions of the part, thereby leaving areas of paint layer 504 and areas of exposed chrome 502. The areas of exposed chrome 502 generally corresponds to the closed portions of the mask, with the areas of paint corresponding to the open portions of the mask. Graphic designs or shapes can then be added to the remaining painted areas, with removal of the coating or paint layer 504 in selected areas by laser ablation. Benefits of this embodiment include the ability to increase visual impact of selected designs and to consolidate parts, thus reducing overall workpiece complexity, assembly costs, and weight.

The use of the mask 622 may be added to the process 100 prior to the painting step 110, and may be considered as part of the painting step 110. Put another way, use of the mask may be part of the painting step where selective areas are painted, with the mask defining, at least in part, the areas that will be painted and the areas that will not be painted.

The process 100, including the surface treatment and laser ablation, is also an improvement over traditional mask and paint techniques. The laser ablation step 114 of the process 100 makes it possible to accommodate designs where masking or inverse masking is not feasible. For example, masking may be difficult to perform depending on the shape of the workpiece/part/component that is to be painted. Some curved surfaces or recessed areas may not be able to receive the shape of the desired mask. By using laser ablation, it is possible to create crisper paint lines compared to those created solely from masking, which require a tight fit over the entire mask portion of the part. Additional benefits of the use of laser ablation include reduced tooling costs, because a large quantity of masks may no longer be needed to be created or maintained. Even if masks are used, such masks may be easier to use due to the use of laser ablation for the more detailed areas. For example, a more general mask may be used, with the shape of the design being refined via the use of laser ablation at the edges of the general shape defined by the mask.

Another benefit of the process 100 is the allowance for more customization of a part, thereby making it more attractive to OEMs who can design trim levels for vehicles without the need for additional tooling. For example, the same shape of a decorative component may be used for the same vehicle, with different ablation patterns applied to the component to define the different trim levels. In such instances, it is not necessary to make, store, and maintain different masks to create the varied appearances for the different trim levels. Instead, the pattern of the laser ablation may be varied to alter the shape of the design.

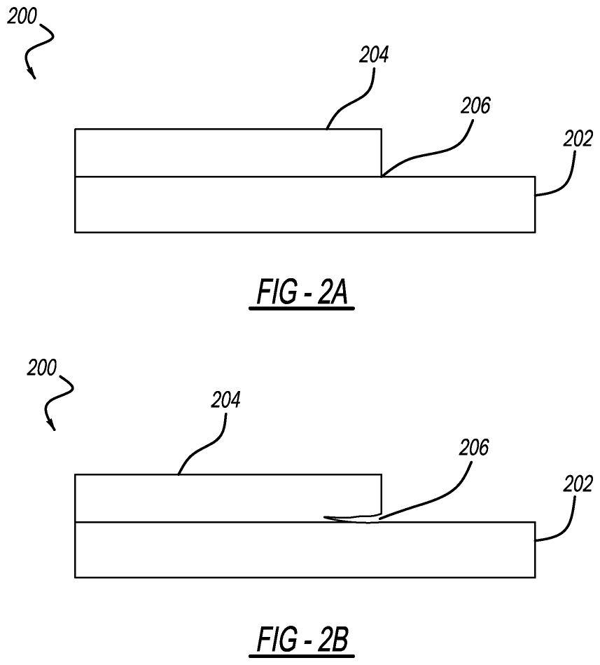

Additionally, the performance of the treated and coated chrome metal surface 502 is improved relative to non-treated chrome surfaces. It is known to those skilled in the art that exposed paint-metal interfaces are particularly susceptible to adhesion failure. Consequently, the exposed paint-metal interfaces formed after laser ablation of non-treated workpiece surfaces are particularly vulnerable to loss of adhesion. Testing of treated and untreated chrome metal surfaces shows the surface pretreatment process described herein results in better adhesion of the paint/coating, particularly at the exposed paint-metal interfaces. The effect of adhesion failure, which is overcome by the process of the present disclosure, is illustrated in FIG. 2.

As shown in FIG. 2A, a workpiece 200 is shown having a chrome metal surface portion 202 with a paint/coating layer 204 applied thereto. The metal surface 202 illustrated in FIG. 2 is a non-treated metal surface. FIG. 2A therefore illustrates a non-treated workpiece 200 that has the paint/coating 204 applied, which may then be laser-ablated. Alternatively, FIG. 2 may illustrate a paint/coating 204 that was applied using a mask. In either case, the non-treated chrome-metal surface 202 is exposed, and a paint-metal interface 206 is defined at the interface between the exposed chrome surface 202 and the paint layer 204. Following CASS testing, adhesion failure occurs at the interface 206, as shown in FIG. 2B.

It will be appreciated that that the part of the present disclosure may be a chrome metal part or instead may be a plastic part with a chrome plated metal surface. It will also be appreciated that instead of chrome, other metal substrates and/or other metal plating layers may be employed. Whether a metal part or a plated plastic part, the part includes an outer metal surface 502, such as a chrome surface, that may be treated, painted, and laser ablated as described herein, without the adhesion failure illustrated in FIG. 2B.

Additionally, it has also been demonstrated that Five Finger Scratch testing shows that coated pretreated chrome surfaces 502 perform better than untreated chrome surfaces 202. Results from these tests show untreated chrome surfaces 202 failing with adhesion loss at the paint-metal interface 206, similar to the failure illustrated in FIG. 2. Parts created via the process 100 described herein, however, obtain passing results with the parts having coated pretreated chrome surfaces 502.

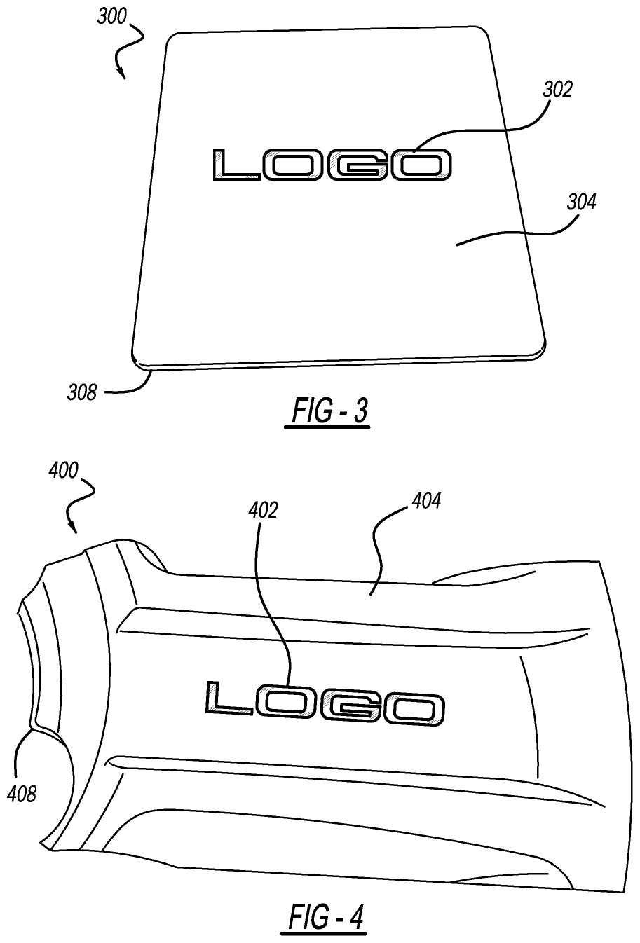

According to an aspect, an example of a chrome plated surface that has had the prescribed surface pretreatment followed by paint steps 110-112 and laser ablation steps 114 is shown in FIGS. 3 and 4, as well as FIGS. 5A and 5B.

In the embodiment of FIG. 3, the part 300 is nearly planar. The part 300 includes an injection molded ABS plastic 308 that has been chrome plated with metal layer 302 through a known and previously disclosed process, for example via electroplating or other metal deposition procedure to perform the chrome plating. It will be appreciated that other metal materials could also be disposed. Alternatively, the part 300 may be made of metal rather than plated ABS. For the purposes of discussion, the chrome plated version of the part 300 will be described.

After chrome plating, the part includes outer metal surface 502. The treatment, painting, and ablation of process 100 was applied to the part 300, such that paint layer 304 is applied over surface 302. For example, according to an aspect, the part 300 with the outer metal surface 302 was surface treated in accordance with one or more of steps 102-108 as previously described for process 100, painted via steps 110-112 of process 100 with tinted polyurethane and subjected to laser ablation via step 114 of process 100. As can be seen in FIG. 3, the metallic graphic design contains a bare chrome surface 302 (created via laser ablation of a treated and painted chrome surface) while the remaining area of the piece is covered in a paint 304 (where laser ablation did not occur). The paint layer 304 can be a dark opaque paint, in one example. The bare chrome surface 302 may also be described as an exposed portion of the outer metal surface.

FIG. 3 represents an example of the paint layer that was applied in steps 110-112 being removed to define the shape of the desired pattern. In FIG. 3, the pattern is a series of letters “TRD,” however the pattern could be other shapes, letters, numbers, logos, etc. The use of laser ablation may completely remove the material in a pattern corresponding to the desired pattern, or the laser ablation may be used to refine a pattern that was defined by a mask, where a portion of the outer metal surface was not painted, and the laser ablation expands the bare, unpainted portion outwardly and with a defined outer profile.

In another aspect, the laser ablation may be applied to remove the painted layer 304, such that the pattern or logo is the shape of the painted layer 304 that is left over, with the bare outer metal layer 302 as the “background” or surrounding portion of the desired pattern, logo, or the like. In this aspect, a mask may be used to provide paint that covers the area where the logo is to be defined, leaving the rest of the outer metal 302 surface un-painted. In this aspect, less paint can be used.

It will be appreciated that the example of FIG. 3 may be similarly representative of painting with other colors or tints or materials. The painting process may include the use of a mask that defines one or more portions of the ablated logo.

In yet another aspect, FIG. 4 depicts a 3-dimensional part 400 having undergone a similar process 100, with the base part or substrate 408 (with metal layer 402) having a more complex shape than that of FIG. 3 (which had generally flat shape). Paint layer 404 may be applied and ablated according to the processes described herein.

It is particularly advantageous to use injection molded chrome plated plastic parts because it allows for a nearly infinite number of shapes to be formed giving designers wide flexibility in determining what will be aesthetically pleasing to the consumer. Furthermore, the shape and contour of the workpiece/part can be used to enhance the inherent reflectivity of the part even when covered with a tinted topcoat according to the process 100.

The laser ablation on the part 400 in FIG. 4 was done on a generally planar portion of the part 400 but the present disclosure is not limited to that restriction. For example, the laser ablation can be performed on a curved or rounded surface, or an edge of the part 400. The ability to perform the ablation on a variety of surfaces increases the variety of possible patterns beyond manual painting or the use of masks, which are difficult to locate within recessed areas or on curved surfaces. Additionally, the part 400 can be rotated or moved relative to the position of the laser in order to provide a surface that is accessible to the laser, resulting in paint removal from more than one plane.

Another embodiment of the invention, shown schematically in FIGS. 5A-5B, involves creating a part 500 according to the process 100 having a pretreated, painted, and chromed 3-dimensional textured surface 510, and using the laser ablation technique (step 114 of process 100) to specific repeating areas of the textured surface 510.

FIG. 5 illustrates this concept by depicting a cross section of an array of surface features 512, shown as multiple pyramid shapes that are distributed across the surface of the part 500 to create the textured surface 510. It will be appreciated that a variety of different surface features may be used. For example, hemispherical features may project from the surface, or conical shapes may project from the surface. For the purposes of discussion, the pyramidal shapes shown in FIG. 5 will continue to be referenced.

In this instance, a chrome plated, and textured, plastic workpiece 500 is painted (according to steps 110-112). After selective removal of paint (via laser ablation of step 114) on only the tops/peaks 512a of the pyramidal structures 512, a unique appearance may be obtained. The amount of paint removed from each top/peak may be consistent across the textured surface for each feature. Alternatively, the amount of paint that is removed from the top/peak may vary among the various surface features.

As described above, the concept is not limited to the pyramidal features 512 of course, but may involve another repeating geometric shape, such as hemispheres, undulating waves, or the like. According to an aspect, the textured surface 510 need not be formed by geometric shapes at all, rather it may incorporate some amorphous shape or repeating unit of two or more geometric 3-dimensional structures. Thus, the features 512 may also be referred to as a 3-dimensional structure 512 or shape 512, which be appreciated to encompass the various arrays of shapes contemplated herein. In another aspect, the features 512 may be of different shapes, and/or may be arranged in a “random” or inconsistent spacing or repetition.

The diagram of FIG. 5B is also not intended to limit the paint removal only to the tops 512a of the shapes 512. In one aspect, valleys 512b in this particular case can be selectively ablated or targeted areas of the facets. Similar to the tops/peaks, the valleys 512b may have differing amounts of paint removed at different locations. In both cases, some of the peaks/valleys may not have any paint removed, while others do have paint removed. The selection of which peaks/valleys have paint removed, and by how much, may be tailored according to the pattern, image, or graphic that is desired. In one example, the right side of FIG. 5B illustrates the paint layer 504 remaining on the peak 512a with paint removed from the valley 512b.

With continued reference to FIG. 5A, the part/workpiece 500 may include a chrome-metal surface layer 502, a paint layer 504 disposed over the chrome-metal surface layer 502, with the chrome-metal surface layer applied over plateable plastic material 508 of the workpiece 500 (such as injection molded plastic).

FIG. 5B illustrates the state of the part 500 following laser ablation. The interface 506 between the paint layer 504 and the chrome surface 502 is shown in the areas where laser ablation has occurred (FIG. 5B). The primer layer is disposed between the chrome surface 502 and the paint layer 504, and is therefore also illustrated in FIG. 5B. The paint-metal interface 506 or design border is typically free from adhesion failure or the like due to the treatment of the metal surface 502 (described previously with respect to process 100) and the use of laser ablation to remove the desired portions of the paint layer 504. This clean interface is in contrast to the adhesion failure shown in FIG. 2.

Accordingly, the interface 506 provides a clean and precise outline or perimeter to define the shape of a logo, design, or the like on a part having multiple surface appearances, for example both chrome portions and painted portions. This interface 506 according to the process 100 is resistant to adhesion failure and will therefore remain in place and define the desired design for an extended period of time relative to prior solutions.

As described above, the part 500 may also be created using a masking step in which a mask is applied over the treated metal layer 502 prior to applying the paint layer 504 to create a first contrasting surface finish and to save paint that will ultimately be removed. Following application of the paint layer 504, the laser ablation step can still be performed to create the desired interfaces 506, in some cases removing the interface created by the masking. In some instances, for example where a clean and crisp interface may not be necessary, the interface from masking may remain with the ablation being performed in a different area. An example of a masking process in shown in FIG. 6 and described further below.

The schematic of FIG. 5A-5B shows the paint layer 504 and chrome layer 502 to be generally uniform in thickness, however in practice this may not be the case. Typically the valleys 512b formed by adjoining pyramids 512 are lower current density areas during the metal-on-plastic plating process, and therefore may contain thinner metal thicknesses (i.e. a thinner chrome layer 504 applied over the plastic material 508 in these areas) than the peaks 512a. In contrast to the valleys 512b, the peaks 512a may have a higher current density during the plating process, causing a relatively higher metal thickness.

The reverse of the thin metal layer in the valleys 512b is true for the paint layer 504 which will tend to “pool” in the valleys 512b causing greater thicknesses (thicker paint layer 504 applied over the chrome layer 502) than the peaks 512a. The schematic of FIG. 5A-5B is intended to illustrate the concept of the applied layers and the subsequent removal via laser ablation and not to depict actual thicknesses of the respective layers.

According to yet another aspect, shown in FIG. 5C, the part 500 may be formed of a plastic material, such as plastic material 508. According to this aspect, only portions of the surface of plastic material 508 may be subjected to a chrome plating process such that a partial chrome layer 502 is selectively disposed on only portions of the surface of plastic material 508. The unplated portions 508a of the plastic material 508 may be either opaque or translucent, and may be visible through the metal layer 502. The paint layer 504 may be disposed over the metal layer 502 (after the metal layer 502 has been treated as described above) such that portions of the metal layer 502 are exposed through the paint layer 504. Similar to that described above, the paint-metal interface 506 may be refined via laser ablation. The combination of treatment and laser ablation creates an interface that is resistant to adhesion failure.

According to still a further aspect, a light source 520 may be disposed adjacent to the translucent portion of the plastic material 508 such that that light may pass through the plastic material 508 and be visible through the bare portion 508a, yielding varying and distinct surface finishes on a single part. The bare portion 508a and/or the use of the light source 520 may be applied to the other embodiments described herein.

Turning now to FIG. 6, one example of a part 600 is shown, in which a plateable material 608 has been plated with a metal material to define metal surface 602. The metal surface 602 may be treated as described above. A mask 622 is shown positioned above the metal surface 602 in an exploded configuration. It will be appreciated that the mask 622, when used, may be placed on or adjacent the metal surface 602. A paint sprayer 624 is positioned above the mask 622 such that the mask 622 is disposed between the metal surface 602 and the sprayer 624.

As shown in FIG. 6, the mask 622 is arranged to define a series of letters, such that the paint will fill the open space and create painted letters, with the area outside of the letters being blocked from paint. Accordingly, in this arrangement, the area surrounding the letters will be exposed metal. It will be appreciated that the mask 622 may also represent the reverse, where the mask is in the shape of the letters, such that the paint surrounds the letters, and the metal surface defining the shape of the letters is surrounded by the paint.

In either case, after a rough paint-metal border has been defined by the mask 622 and the sprayed paint, laser ablation may be performed to refine the paint-metal interface and the shape of the pattern, logo, or the like.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A decorative component for an automotive vehicle, the decorative component comprising:
a metal substrate having an outer metal surface;
wherein the outer metal surface is substantially free from oxidation following an oxidation removal treatment process to define a treated metal surface;
a paint or coating layer applied and adhered to the treated outer metal surface;
a portion of the paint or coating layer removed by a laser ablation process to expose a portion of the metal layer to define a paint-metal interface.

2. The decorative component of claim 1, further comprising a primer layer applied on the outer metal surface and disposed between the outer metal surface and the paint or coating layer.

3. The decorative component of claim 1, wherein the treatment process defining the treated metal surface occurs prior to painting.

4. The decorative component of claim 1, wherein the paint-metal interface is free from adhesion failure.

5. The decorative component of claim 1, wherein the component includes multiple surface finishes to define a graphic on the component.

6. The decorative component of claim 1, wherein the paint-metal interface is disposed on a flat surface of the component.

7. The decorative component of claim 1, wherein the paint-metal interface is disposed on a curved surface of the component.

8. The decorative component of claim 1, wherein the metal substrate has a textured surface including a plurality of protruding features.

9. The decorative component of claim 8, wherein the textured surface defines a plurality of peaks and valleys.

10. The decorative component of claim 9, wherein the peaks define an exposed metal surface formed by laser ablation and the paint-metal interface is disposed on a side surface of the protruding features.

11. The decorative component of claim 9, wherein the valleys define an exposed metal surface formed by laser ablation and the paint-metal interface is disposed on a side surface of the protruding features.

12. The decorative component of claim 1, wherein the metal substrate consists of a chrome metal part.

13. A method of creating a surface finish on a decorative component for an automobile, the method comprising the steps of:
providing a workpiece formed of a metal material, the workpiece having an outer metal surface;
treating the outer metal surface with an oxidation removal treatment process and defining a treated metal layer;
after treating the outer metal surface to define the treated metal layer, applying a paint layer over the treated metal layer;
removing a portion of the paint layer using laser ablation and defining a metal-paint interface.

14. The method of claim 13, wherein the step of treating the metal material comprises applying a primer layer to outer metal surface.

15. The method of claim 13, further comprising applying a mask to a portion of the treated metal layer prior to applying the paint layer, and performing laser ablation after applying the mask and the paint layer, wherein the laser ablation removes paint-metal interfaces defined by the mask.

16. The method of claim 13, wherein the outer metal surface includes a textured surface with a plurality of surface features defining peaks and valleys.

17. The method of claim 16, wherein the step of removing a portion of the paint layer comprises removing a portion of the paint layer from the peaks and retaining the paint layer in the valleys.

18. The method of claim 16, wherein the step of removing a portion of the paint layer comprises removing a portion of the paint layer from the valleys and retaining the paint layer on the peaks.

19. The method of claim 13, further comprising rotating the workpiece during laser ablation.

20. The method of claim 13, wherein the laser ablation creates a crisp metal-paint interface free from adhesion failure.
